(19) United States
(12) Patent Application Publication
(10) Pub. No.: US 2010/0040998 A1
(43) Pub. Date: Feb. 18, 2010

(54) Paint Memorialization Kit

(76) Inventor: Nancy Anne Thurston, Richmond, VA (US)

Correspondence Address: HARSHAW RESEARCH, INC., 210 W. TECUMSEH STREET, OTTAWA, KS, 66067, US

(21) Appl. No.: 12/192,572

(22) Filed: Aug. 15, 2008

(51) Int. Cl. G09B 11/00; B65D 69/00

(52) U.S. Cl. 434/84; 434/81; 206/575

(57) ABSTRACT

A paint memorialization kit includes a plurality of elongate color identifying elements, each having generally planar front and rear sides and having opposed first and second ends. Each second end includes a tab extending upwardly therefrom for use in identifying the color identifying elements. Each front side first end includes indicia requesting color information, texture information, and brand information of paint received on a respective second end. The kit includes a case having a first area for receiving the color identifying elements and a second area for receiving paint paraphernalia, the first area including partitions for separating the color identifying elements from one another and maintaining the color identifying elements in an upright configuration. The case includes a lid movable to selectively cover and expose the first and second areas.

### BACKGROUND OF THE INVENTION

This invention relates generally to painting accessories and, more particularly, to a kit for storing and memorializing paint color samples and associated information so that paint colors used recently may be remembered, identified, and reconstituted at a later time.

After painting an item, whether the exterior of a house, an interior room, or some smaller item, the painter often desires to save a sample of the paint and its associated information so as to be able to purchase more of the same color and type of a respective paint at a later time when the painted item needs to be repainted or touched up.

Various devices and methods have been proposed for keeping a record of what color of paint has been used in the past. For example, saving paint lids, paint cans with only a small amount of remaining paint, paint sticks, or paper color samples are traditional methods used by amateur painters to keep a record of the paint. Although assumably effective for their intended purposes, these methods are generally undesirable in that they may cause cumbersome and unsightly storage problems, result in lost information, or are generally unreliable to memorialize a perfect color match. As paint formulations and textures change over time, it is sometimes difficult to match old paint perfectly without date information or a paint stick that may be computably matched at a paint store.

Therefore, it would be desirable to have a paint memorialization kit that includes a case having slots for receiving and storing multiple paint sticks as well as an area for other paint accessories. Further, it would be desirable to have a paint memorialization kit in which the paint sample sticks include index tabs for quick sight reference and that include areas for information such as area painted, color, texture, and brand of paint.

### SUMMARY OF THE INVENTION

A paint memorialization kit according to the present invention includes a plurality of elongate color identifying elements (e.g. paint sticks), each elements having generally planar front and rear sides and having opposed first and second ends. Each second end includes a tab extending upwardly therefrom for use in identifying the color identifying elements. Each front side first end includes indicia requesting color information, texture information, and brand information of paint received on a respective second end.

The kit includes a case having a first area for receiving the color identifying elements and a second area for receiving paint paraphernalia, the first area including partitions for separating the color identifying elements from one another and maintaining the color identifying elements in an upright configuration. The case includes a lid movable to selectively cover and expose the first and second areas.

The paint paraphernalia may include a paint can opener, spatula, or the like. The front side first end of a first color identifying element has paint-related information placed thereon to identify a respective paint. In addition, the second end of the first color identifying element is painted with the respective paint.

Therefore, a general object of this invention is to provide a paint memorialization kit for organizing and storing multiple paint sticks representative of areas that have previously been painted by a user.

Another object of this invention is to provide a paint memorialization kit, as aforesaid, in which each paint stick includes a color presentation area that is positioned for easy sight identification.

Still another object of this invention is to provide a paint memorialization kit, as aforesaid, for inscribing reference information onto a respective paint stick.

Yet another object of this invention is to provide a paint memorialization kit, as aforesaid, that includes a robust case having an area for the paint identification sticks and also for select paint accessory items.

A further object of this invention is to provide a paint memorialization kit, as aforesaid, that is cost-effective to manufacture and user-friendly to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a paint memorialization kit according to a preferred embodiment of the present invention with a case lid in a closed configuration;

FIG. 1b is another perspective view of the paint memorialization kit with the case lid in an open configuration;

FIG. 2 is an exploded view of the paint memorialization kit as in FIG. 1b;

FIG. 3 is a top view of the paint memorialization kit as in FIG. 1b;

FIGS. 4a to 4d are front views of respective paint identifying elements illustrating the differing tab configurations; and

FIG. 5 is a rear view of a paint identifying element

### DESCRIPTION OF THE PREFERRED EMBODIMENT

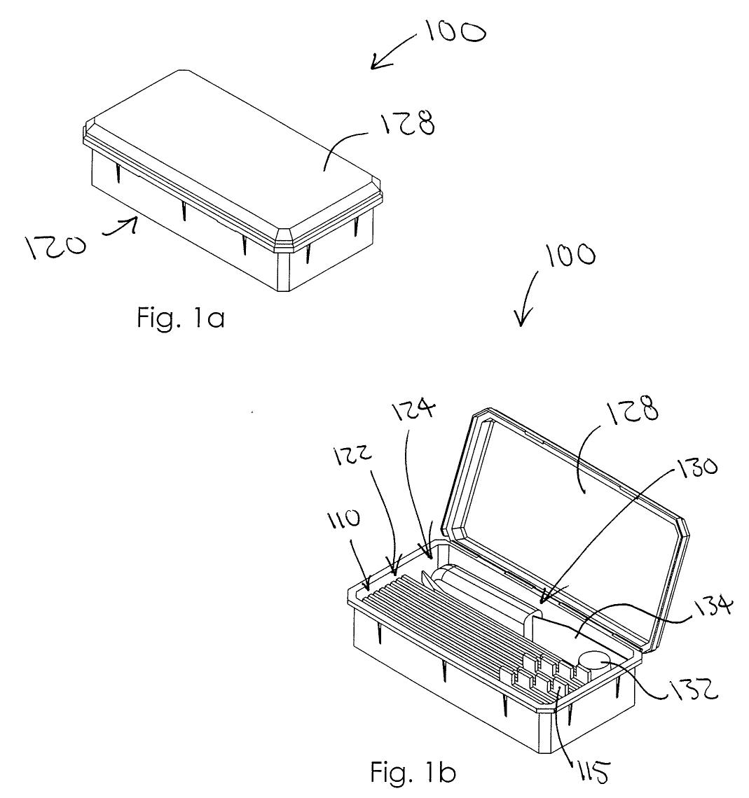

A paint memorialization kit will now be described in detail with reference to FIG. 1a through FIG. 5 of the accompanying drawings. More particularly, a paint memorialization kit 100 includes a plurality of elongate color identifying elements 110 and a case 120

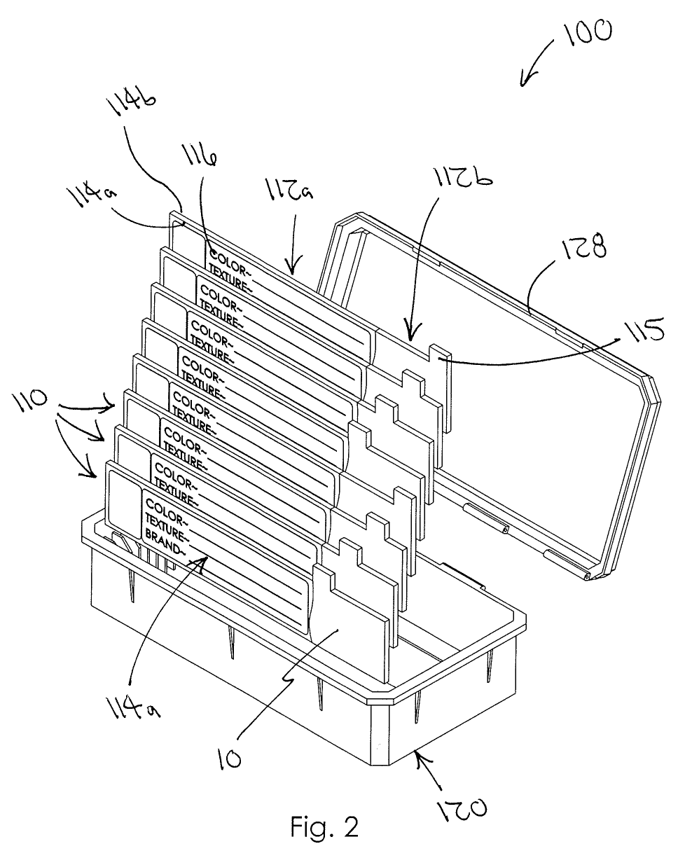

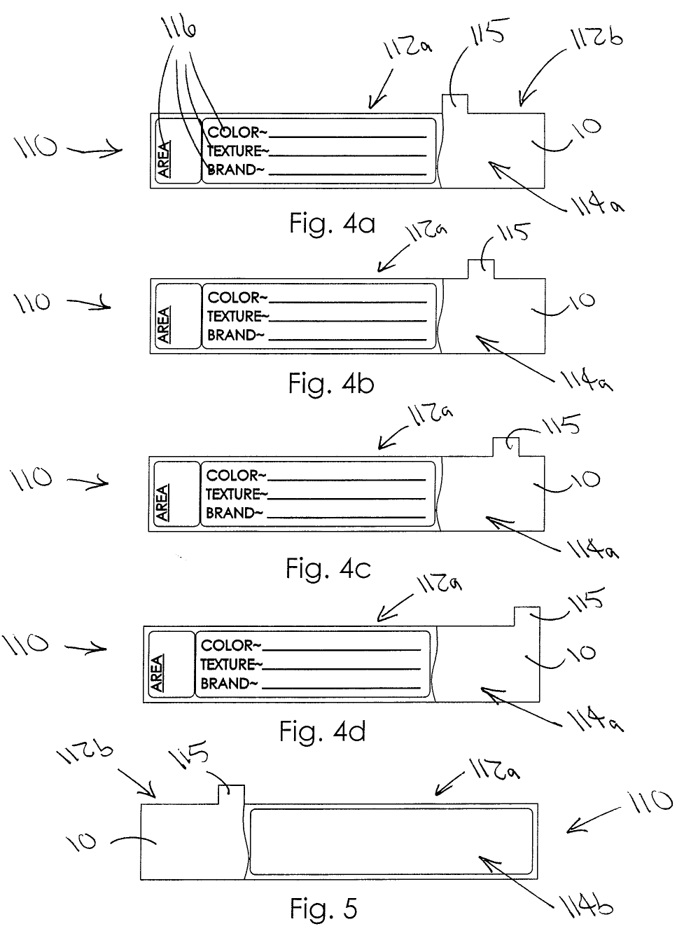

As shown in FIG. 2 and FIGS. 4a through 5, each color identifying element 110 has a first end 112a to receive written indicia and an opposed second end 112b to receive paint 10. The color identifying elements 110 may have generally planar front and rear sides 114a (FIGS. 4a through 4d), 114b (FIG. 5) with a portion of the front and rear sides 114a, 114b defining the first end 112a and another portion of the front and rear sides 114a, 114b defining the second end 112b. Each second end 112b includes a tab 115 extending upwardly therefrom for use in identifying the color identifying elements 110 as described below. The front and rear sides 114a, 114b may be generally rectangular (as shown throughout the drawings), hourglass-shaped, or any other acceptable shape, and may be constructed of wood, plastic, metal, or any other appropriate material.

The first end 112a of each front side 114a may include indicia 116 requesting color information, texture information, brand information, area information (i.e., information regarding where the respective paint was applied), and/or other paint-related information (i.e., information related to the respective paint 10 received on the second end 112b of the color identifying element 110), as shown in FIGS. 4a through 4d. The first end 112a of each rear side 114b may include an area for non-predetermined indicia (i.e., notes and/or other indicia desired by the user but not specifically requested by indicia on the rear side 114b).

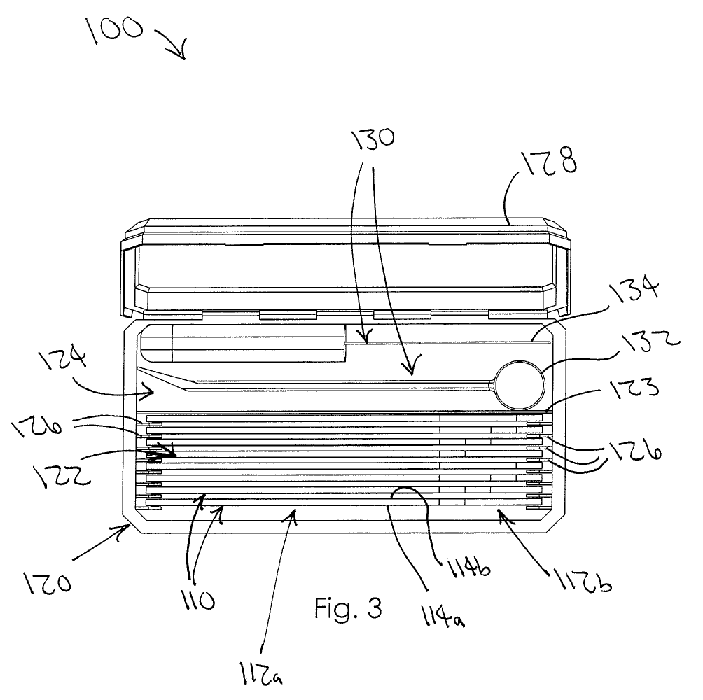

The case 120 has a first area 122 for receiving the color identifying elements 110 and a second area 124 for receiving paint paraphernalia. The first and second areas 122, 124 may be separated by a wall 123 (FIG. 3). As shown in FIG. 3, the first area 122 includes partitions 126 for separating the color identifying elements 110 from one another and maintaining the color identifying elements 110 in an upright configuration (i.e., with the tabs 115 pointing upwardly, as shown in FIG. 1b). The case 120 may include a lid 128 that is movable (e.g., hingedly movable) to selectively cover the first and second areas 122, 124 (FIG. 1a) and selectively expose the first and second areas 122, 124 (FIG. 1b).

As shown in FIG. 1b and FIG. 3, paint paraphernalia 130 (e.g., a paint can opener 132, spatula 134, etc.) may be in the second area 124 of the case 120.

In use, a painter may paint a portion of a building (e.g., interior wall(s), exterior wall(s), ceiling(s), etc.), object, etc. To maintain a record of the paint 10 that was used, paint-related information (e.g., color information, texture information, brand information, area information, etc.) may be placed on the first end 112a of a respective color identifying element 110, and the second end 112b of the color identifying element 110 may be painted with the respective paint 10. The second end 112b may be painted by dipping the second end 112b in a can of the respective paint 10, or by using a paint brush, paint roller, etc. The paint-related information may be placed (e.g., using a pen, sticker, etc.) on the front side 114a of the first end 112a, such as in response to the indicia 116. Non-predetermined indicia (i.e., notes and/or other indicia desired by the user but not specifically requested by indicia on the rear side 114b) may be placed on the rear side 114b of the first end 112a. The respective color identifying element 110 may then be placed in the case 120 (i.e., in first area 122) for future reference. The paint paraphernalia 130 may be used as desired, and it may be desirable to locate the paint paraphernalia 130 with the color identifying elements 110 for storage and retrieval purposes.

When another portion of the building, object, etc. is painted (or when the original portion of the building, object, etc. is painted a different color), to maintain a record of the paint 10 that was used, paint-related information (e.g., color information, texture information, brand information, area information, etc.) may be placed on the first end 112a of a different color identifying element 110, and the second end 112b of this color identifying element 110 may be painted with the respective paint 10. The paint-related information may be placed on the front side 114a of the first end 112a, such as in response to the indicia 116. Non-predetermined indicia (i.e., notes and/or other indicia desired by the user but not specifically requested by indicia on the rear side 114b) may be placed on the rear side 114b of the first end 112a. This color identifying element 110 may then be returned to the case 120 (i.e., in first area 122) along with the first color identifying element 110 for future reference. It should be understood that each of the color identifying elements 110 may be used in this manner to memorialize different paints 10.

To later access the information about a particular paint 10, the user may select the appropriate color identifying element 110 through viewing the tabs 115 or the information on the respective color identifying elements 110, and the paint-related information may be retrieved from the appropriate color identifying element 110.

It is understood that while certain forms of this invention have been illustrated and described, it is not limited thereto except insofar as such limitations are included in the following claims and allowable functional equivalents thereof.

1. A paint memorialization kit, comprising:
a plurality of elongate color identifying elements, each having a first end to receive written indicia and a second end to receive paint, each said second end having a tab extending upwardly therefrom for use in identifying said color identifying elements; and
a case having a first area for receiving said color identifying elements and a second area for receiving paint paraphernalia, said first area including partitions for separating said color identifying elements from one another and maintaining said color identifying elements in an upright configuration, said case having a lid movable to selectively cover and expose said first and second areas.

2. The kit of claim 1, wherein each said color identifying element has generally planar front and rear sides, one portion of said front and rear sides being said first end, another portion of said front and rear sides being said second end.

3. The kit of claim 2, wherein each said front and rear side is generally rectangular.

4. The kit of claim 3, wherein each said front side first end has indicia requesting color information, texture information, and brand information of paint received on said second end.

5. The kit of claim 4, wherein said color identifying elements are constructed of wood.

6. The kit of claim 4, further comprising paint paraphernalia in said case second area, said paint paraphernalia including at least one of a paint can opener or spatula.

7. The kit of claim 1, further comprising paint paraphernalia in said case second area, said paint paraphernalia including at least one of a paint can opener or spatula.

8. A paint memorialization kit, comprising:
a plurality of elongate color identifying elements, each having generally planar front and rear sides and having opposed first and second ends, each said second end having a tab extending upwardly therefrom for use in identifying said color identifying elements;
a case having a first area for receiving said color identifying elements and a second area for receiving paint paraphernalia, said first area including partitions for separating said color identifying elements from one another, said case having a lid movable to selectively cover and expose said first and second areas;
wherein said first end of a first said color identifying element has paint-related information placed thereon to identify a respective paint; and
wherein said second end of said first color identifying element is painted with the respective paint.

9. The kit of claim 8, wherein:
said first end of a second said color identifying element has paint-related information placed thereon to identify another respective paint; and
said second end of said second color identifying element is painted with the another respective paint.

10. The kit of claim 9, further comprising paint paraphernalia in said case second area, said paint paraphernalia including at least one of a paint can opener or spatula.

11. The kit of claim 10, wherein each said front side first end has indicia requesting color information, texture information, and brand information of paint received on said second end.

12. The kit of claim 11, wherein each said front and rear side is generally rectangular.

13. The kit of claim 8, wherein each said front side first end has indicia requesting color information, texture information, and brand information of paint received on said second end.

14. A paint memorialization kit, comprising:
a plurality of elongate color identifying elements, each having generally planar front and rear sides and having opposed first and second ends, each said second end having a tab extending upwardly therefrom for use in identifying said color identifying elements; each said front side first end having indicia requesting color information, texture information, and brand information of paint received on a respective second end;
a case having a first area for receiving said color identifying elements and a second area for receiving paint paraphernalia, said first area including partitions for separating said color identifying elements from one another and maintaining said color identifying elements in an upright configuration, said case having a lid movable to selectively cover and expose said first and second areas;
paint paraphernalia in said case second area, said paint paraphernalia including at least one of a paint can opener or spatula;
wherein said front side first end of a first said color identifying element has paint-related information placed thereon to identify a respective paint;
wherein said second end of said first color identifying element is painted with the respective paint; and
wherein said rear side first end of said first color identifying element includes non-predetermined indicia.

15. The kit of claim 14, wherein said case includes a wall separating said first and second areas.

16. The kit of claim 15, wherein each said front and rear side is generally rectangular.

17. The kit of claim 14, wherein said second end of said first color identifying element is painted with the respective paint by dipping said second end of said first color identifying element in a can of the respective paint.

18. The kit of claim 14, wherein said case lid is hingedly movable to selectively cover and expose said first and second areas.

19. The kit of claim 14, wherein:
said front side first end of a second said color identifying element has paint-related information placed thereon to identify a second respective paint;
said second end of said second color identifying element is painted with the second respective paint; and
said rear side first end of said second color identifying element includes non-predetermined indicia.

20. The kit of claim 19, wherein:
said case includes a wall separating said first and second areas;
each said front and rear side is generally rectangular;
said second end of said first color identifying element is painted with the respective paint by dipping said second end of said first color identifying element in a can of the respective paint;
said case lid is hingedly movable to selectively cover and expose said first and second areas; and
said color identifying elements are constructed of wood.
